(19) United States
(12) Patent Application Publication
(10) Pub. No.: US 2004/0246116 A1
(43) Pub. Date: Dec. 9, 2004

(54) Tire pressure loss recognition during trailer operation

(76) Inventor: Norbert Polzin, Zaberfeld (DE)

Correspondence Address: KENYON & KENYON, ONE BROADWAY, NEW YORK, NY, 10004, US

(21) Appl. No.: 10/481,494

(22) PCT Filed: Feb. 7, 2003
(86) PCT No.: PCT/DE03/00352

(30) Foreign Application Priority Data
Jun. 19, 2002 (DE) 102 27 280.8

(51) Int. Cl. B60C 23/00

(52) U.S. Cl. 340/443

(57) ABSTRACT

The present invention describes a method and a device for monitoring an operating state of at least one tire of vehicle as a function of the coupling of a trailer to the vehicle. In this context, the operating state of the tire, i.e. the tire state, is particularly monitored for changes. Operation of the vehicle with a trailer causes the distribution of the axle load between the front and rear axles to change in the towing vehicle. This manifests itself in changed slip conditions for the wheels on both the front axle and the rear axle and results in the wheel speeds in trailer operation differing from those in trailerless operation, when the conditions are otherwise the same. Now, the essence of the present invention is to modify the wheel-speed-based monitoring of the tire state on the basis of detecting that the vehicle is being operated with a trailer. This modification allows, e.g. a loss in pressure of a tire to be determined with a better detection accuracy.

### FIELD OF THE INVENTION

The present invention relates to a method and a device for monitoring a tire state of a vehicle during operation of the vehicle with a trailer.

### BACKGROUND INFORMATION

Other systems monitor the state, e.g., the air pressure, of a tire. In addition to the direct determination of the air pressure of a tire, the rotational speeds of the wheels may be used to determine a change in the tire pressure. Thus, the changes in the rotational speeds of individual wheels are determined and used to show the change in the state of the tires. Systems to this effect, which display the tire state in certain operating states (unbraked, constant-speed, straight-ahead driving), are discussed in German Published Patent Application No. 36 10 116 and in German Published Patent Application No. 32 36 520. In addition, these documents discuss that the rotational speeds be normalized to the specific vehicle speed.

The use of differences in the rotational wheel speeds of individual wheels to detect the tire state is discussed in European Published Patent Application No. 0 291 217.

German Published Patent Application No. 199 44 391 discusses the adjustment of a calibration value used to monitor the tire pressure. In this context, the tire-pressure system is newly calibrated on the basis of a changed operating state of the wheel, the old value being overwritten.

### SUMMARY OF THE INVENTION

The exemplary embodiment and/or method of the present invention is directed to a method and a device for monitoring an operating state of at least one tire of vehicle as a function of the coupling of a trailer to the vehicle. In this context, the operating state of the tire, i.e. the tire state, is particularly monitored for changes. Operation of the vehicle with a trailer causes the distribution of the axle load between the front and rear axles to change in the towing vehicle. This manifests itself in changed slip conditions for the wheels on both the front axle and the rear axle and results in the wheel speeds in trailer operation differing from those in trailerless operation, when the conditions are otherwise the same. Thus, especially in the case of a vehicle having front-wheel drive, load is removed from the front axle during trailer operation, and, as a result, the wheels of the front axle run with higher slip, i.e. rotate faster. In the case of rear-wheel drives, higher normal forces during trailer operation lead to less drive slip. Now, the essence of the present invention is to modify the wheel-speed-based monitoring of the tire state on the basis of detecting that the vehicle is being operated with a trailer. This modification may allow, e.g. a loss in pressure of a tire to be determined more accurately.

A further exemplary embodiment provides that the monitoring of the tire state is accomplished with the aid of a tire-state variable representing the tire state. In this context, the tire-state variable is formed by wheel-dynamics variables, which correspond, for their part, to the wheel speeds at the wheels being considered. In this context, the tire-state variable may be determined in a different manner. Thus, an exemplary embodiment of the present invention consists in calculating a sum of at least two wheel speeds. In this context, the sum of the wheel speeds may be calculated both by axle, e.g. front and rear axles, and by side, e.g. right and left sides. However, the differences of the wheel speeds may be calculated in the same manner as calculating the sums.

Thus, the difference between at least one wheel of the front axle and one wheel of the rear axle may be calculated in a further exemplary embodiment of the present invention, the difference especially being calculated for diagonally arranged wheels. A further exemplary embodiment of the present invention normalizes the calculated sum or difference of the wheel speeds to the vehicle speed.

The monitoring is also provided by comparing a tire-state variable respresenting the current operating state of the tire, to a calibration data record. In this context, it is provided that the calibration data record be formed (calculated) at specified times. This may occur independently of the driver, e.g. in the event of a tire change, or be accomplished by a command initiated by the driver of the vehicle. In the first case, the fact that a new tire means a change in the tire state and consequently requires recalibration of the data record is taken into account. In the second case, the driver may, however, react to specific circumstances prior to or during vehicle operation, which bring about a change in state of the tire and render recalibration necessary.

In another exemplary embodiment of the present invention, trailer operation may be detected in several manners, only one verification of the presence of a trailer on the vehicle being necessary.

Thus, the trailer may be detected via its electrical coupling, via a mechanism in the trailer hitch, via a switch to be operated manually, using driving-dynamics characteristics of the vehicle, whereby, e.g., the torque balance is to be named, using the normal forces at the wheels of the vehicle, and/or using the power balance of the electrical loads.

An expansion of the monitoring relates to considering the bearing load of the trailer on the vehicle. This is accomplished by modifying the calibration data record as a function of the bearing load. In this context, the bearing load may be determined, using the change in the weight force on the vehicle during trailer operation. If an exact determination of the weight force is not available, then the calibration data record may also be modified with the aid of a constant stipulated beforehand.

In addition, the tire state is monitored by determining a current tire-state variable. If the instantaneously determined tire-state variable deviates from the calibration data record by more than a predefined value, then a loss of pressure of the tire is detected and a malfunction is signaled.

In this context, an addition to the present invention provides that, when a malfunction is detected, i.e. when a pressure loss occurs in a tire, the driver is acoustically and/or optically informed of this.

In light of the detected malfunction of the tire state, another exemplary embodiment of the present invention provides for the control of a driving-dynamics system in the vehicle being able to be modified so as to stabilize the vehicle. Thus, a braking system, which may be specifically controlled in response to the detected, decreased tire pressure in a tire, is provided in an exemplary embodiment. However, in addition to the brake system, an active steering system or a suspension-control system may also be triggered on the basis of the detected pressure loss of a tire, this may allow the driver to guide the vehicle in a safe manner.

### BRIEF DESCRIPTION OF THE DRAWINGS

FIG. 1 shows a block diagram of the detection of the vehicle being operated with a trailer, the monitoring of the operating state of a tire with the aid of the wheel speeds, and the detection of a fault in response to exceeding the required setpoint value.

FIG. 2 shows a flow chart of the initialization of the calibration data records.

FIG. 3 shows a flow chart of the schematic progression for monitoring the tire pressure on the basis of the wheel dynamics.

### DETAILED DESCRIPTION

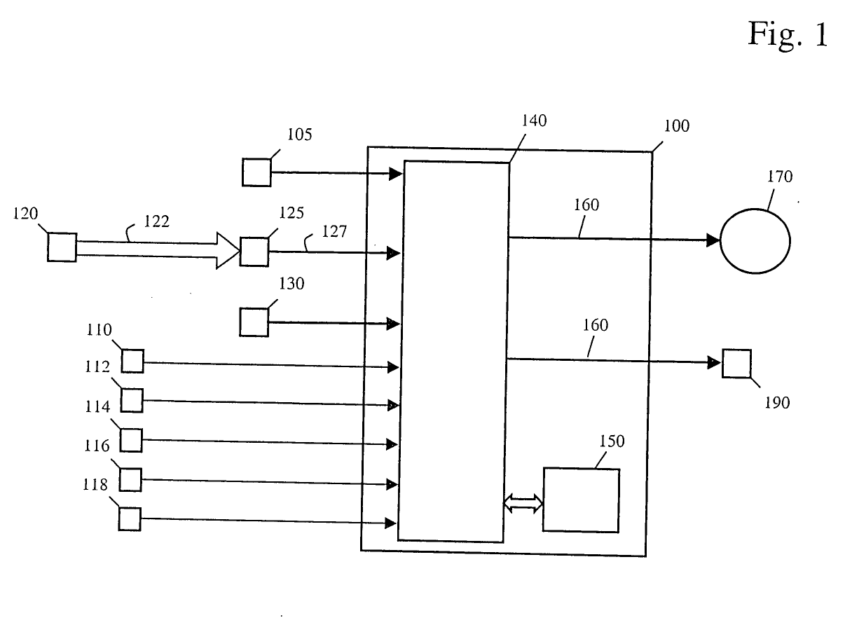

FIG. 1 shows an exemplary embodiment for monitoring a tire state while the vehicle is operated with a trailer. To this end, block 100 is supplied the wheel speeds of the wheels on each individual axle, the wheel speeds representing the wheel dynamics. For the sake of clarity, however, only the wheel speeds of the wheels of the front axle, V_{FL} (110) and V_{FR} (112), and of the rear axle, V_{HL} (114) and V_{HR} (116), are shown in FIG. 1. However, the monitoring may be expanded to several axles, as well as to several wheels per axle. In addition to the wheel speeds of the individual wheels, the speed of the vehicle V_{car} (118) is read in in block 100. In block 140, a tire-state variable representing the tire state of the wheels is ascertained from these read-in values. A flag F_{I} (105) is set for a short time, i.e. flag F_{I} changes from a value of 0 to a value of 1, by an initialization, as may be accomplished manually by the driver or automatically in response to a tire change. In block 140, a calibration data record KDᵢ is generated from the tire-state variable on the basis of set flag F_{I} (105), the calibration data record being stored in memory 150.

To identify trailer operation of the vehicle, the presence of a trailer 120 on the vehicle is checked for in block 125. To this end, different parameters 122 typically associated with trailer operation are queried. Thus, trailer operation may be ascertained, for example, on the basis of the electrical coupling of trailer 120 and/or via a mechanism in the trailer hitch and/or via a switch to be operated manually and/or using the bearing loads on the wheels of the vehicle and/or via the power balance of the electrical loads and/or using driving-dynamics characteristics of the vehicle such as, for instance, the torque balance.

If it is certain from the evaluation of parameters 122, that the vehicle is being operated with a trailer, then a flag F_{A} (127) is set in block 125 and passed on to block 140. On the basis of set flag F_{A} (127), a modification of calibration data record KD is generated in block 140 during the monitoring of the tire state. In this modification, the weight or the bearing load of the trailer is taken into consideration, when the value may be ascertained by an appropriate sensor 130.

If a loss in tire pressure and, therefore, a malfunction 160 is detected during the monitoring of the tire state, the driver is informed by an optical and/or acoustic indicator 170, that at least one of the tires has a loss of pressure.

The detection of a tire pressure loss and malfunction 160 may also be used to trigger a control system 190, which has a directionally stabilizing effect on the vehicle performance. This may be accomplished in that control system 190 directs control signals to an active steering system, a brake system, or other driving-dynamics systems. In this context, another exemplary embodiment provides for the brake interventions of, e.g. an ABS system being taken into consideration in response to a detected, reduced tire pressure, so as to stabilize the vehicle.

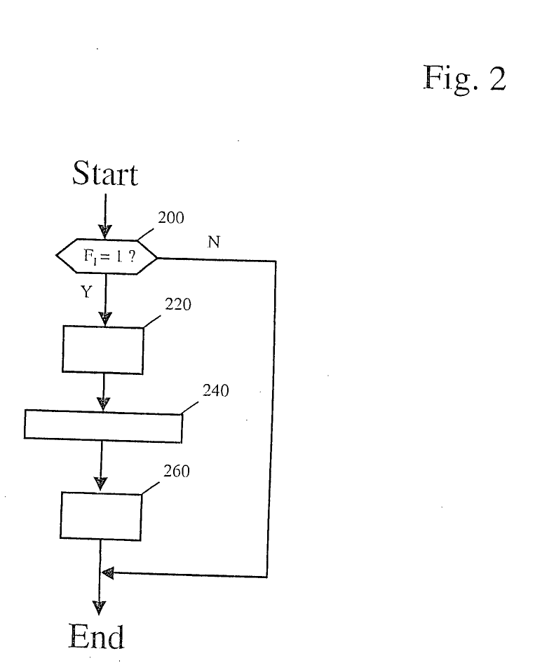

The ascertainment of the calibration data record is represented in FIG. 2. The program is started in regular intervals, in order to query the initialization of the calibration-data set by the driver, or due to other circumstances. To this end, flag F_{I} is queried for an initialization command (F_{I}=1) in step 200. If no initialization command (F_{I}=0) is detected, the program is ended at the next program start. Otherwise, in addition to the wheel rotational speeds of front axle V_{FL} (110) and V_{FR} (112), and of rear axle V_{HL} (114) and V_{HR} (116), which represent the wheel speeds, vehicle speed V_{car} (118) is also read in in step 220. In step 240, different tire-state variables RZᵢ are calculated from these input values according to

RZₗ:Δv_{VA}=(v_{FL}+v_{FR})/v_{car}

RZ₂:Δv_{HA}=(v_{HL}+v_{HR})/v_{car}

and

RZ₃:Δv_{diagonal1}=(v_{FL}+v_{HR})/v_{car}

RZ₄:Δv_{daigonal2}=(v_{FR}+v_{HL})/v_{car}

In subsequent step 260, the tire-state variables are stored in memory 150 as calibration data record KDᵢ. In the present exemplary embodiment, this occurs through the assignment of:

KD₁:=RZ₁

KD₂:=RZ₂

KD₃:=RZ₃

KD₄:=RZ₄

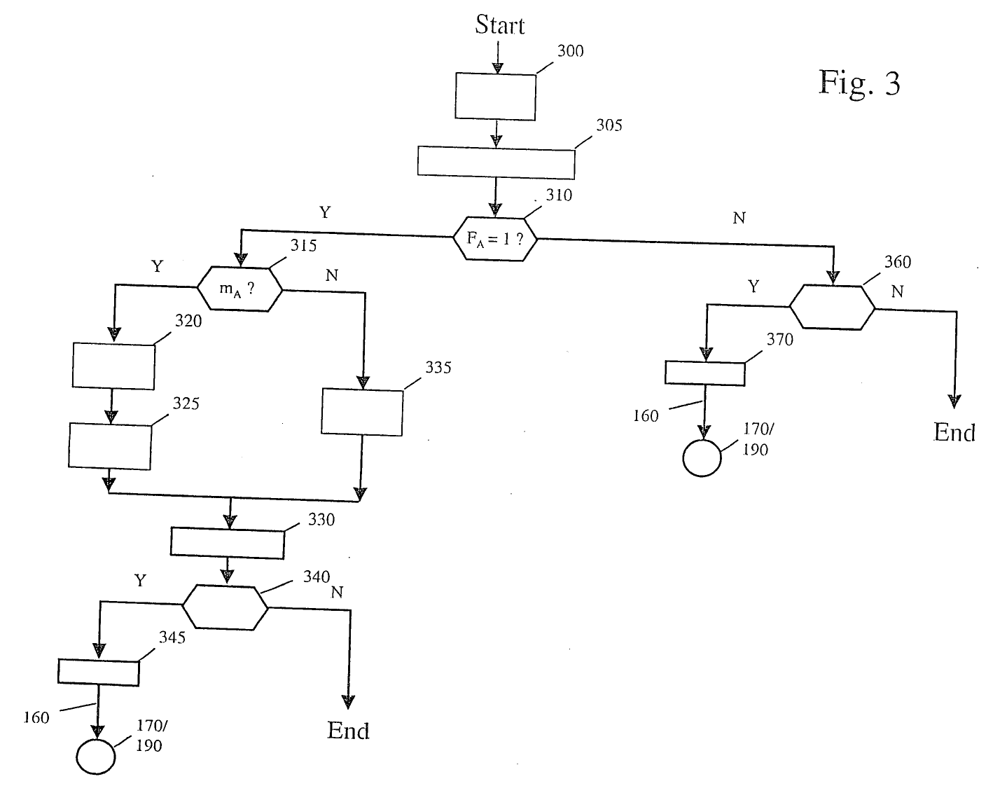

FIG. 3 shows a flowchart of the program for fault detection during the monitoring of the tire state, the program being started in regular time intervals. As already indicated for the calculation of the calibration data record, in addition to the wheel rotational speeds of front axle V_{FL} (110) and V_{FR} (112), and of rear axle V_{HL} (114) and V_{HR} (116), which represent the wheel speeds, vehicle speed V_{car} (118) is also read in in step 300. In step 305, tire-state variables RZ₁ through RZ₄ are calculated from these read-in values according to

RZₗ:ΔV_{VA}=(V_{FL}+V_{FR})/V_{car}

RZ₂:ΔV_{HA}=(V_{HL}+V_{HR})/V_{car}

and

RZ₃:ΔV_{diagonal1}=(V_{FL} −V_{HR})/V_{car}

RZ₄:ΔV_{diagonal2}=(V_{FR} −V_{HL})/V_{Car}

in accordance with the determination of the calibration data record. In subsequent step 310, an inquiry is made via flag F_{A} (127), as to whether the vehicle is being operated with trailer.

If this is not the case (F_{A}=0), then the current tire state of wheels RZᵢ is compared to corresponding calibration data record KDᵢ in step 360. If, in one of the comparisons according to

|KDᵢ−RZᵢ|>SWᵢ (for i=1 . . . 4)

a difference occurs which is greater than at least a value SWᵢ specified beforehand, then a loss of tire pressure and, consequently, a malfunction 160 is detected in step 370. On the basis of this malfunction 160, an acoustic and/or optical display 170 and/or a control system 190 for controlling a directional-stability system is triggered. These directional-stability systems may be an active steering system, a brake system, or another driving-dynamics system. However, if the difference between the calibration data record and tire-state variable does not adequately exceed a previously specified value in the comparison of the current tire state of wheels RZᵢ with corresponding calibration data record KDᵢ, then the program is ended at the next start according to plan.

If set flag F_{A} (127), i.e. F_{A}=1, establishes in step 310, that the vehicle is being operated with a trailer, then, in step 315, an inquiry is made as to if a variable weight of the trailer or a bearing load of the trailer on the vehicle may be ascertained. If an appropriate sensor 130 is available, current weight value GW or bearing load AK is ascertained in step 320. In subsequent step 325, a change variable of threshold value ΔSW is calculated as a function of consequently determined weight value GW or of determined bearing load AK. If no sensor 130 is available for detecting the weight value of the trailer, then, in step 335, the change variable of threshold value ΔSW is assigned a constant value empirically determined beforehand. In a further exemplary embodiment, different change variables of threshold value ΔSW may also be selected for the front and rear axles.

In step 340, the current tire state of wheels RZᵢ is compared to calibration data record KDᵢ. If, in one of the comparisons according to

|KD₁−RZ₁|>SW₁+ΔSW

|KD₂−RZ₂|>SW₂−ΔSW

|KD₃−RZ₃|>SW₃+ΔSW

|KD₄−RZ₄|>SW₄+ΔSW

a difference occurs which is greater than at least one of the specified values, then a malfunction 160 is detected in step 345. On the basis of this malfunction 160, an acoustic and/or optical display 170 and/or a control system 190 for controlling a brake system is triggered. However, if the difference between the calibration data record and tire-state variable does not sufficiently exceed a specified value, then the program is ended at the next start according to plan.

1-12. (Canceled).

13. A method for monitoring an operating state of at least one tire of a vehicle, the method comprising:
providing a tire state of the wheel as an operating state of the tire state of the wheel; and
monitoring the tire state as a function of a coupling of a trailer to the vehicle.

14. The method of claim 13, wherein:
the tire state is monitored using a tire-state variable that represents the tire state; and
the tire-state variable is ascertained by determining, in each case, at least one of a sum of wheel speeds at at least two wheels, and a difference of the wheel speeds between the wheel speeds of at least one wheel of the front axle and one wheel of the rear axle;
wherein the determined value is normalized to the vehicle speed, and the wheel speeds are determined, using a wheel-dynamics variable representing the wheel speed.

15. The method of claim 14, wherein at least one of the following is satisfied:
the sum of the wheel speeds includes at least one of the sum of the wheel speeds at the wheels of one axle, the sum of the wheel speeds at the wheels of the left side and the sum of the wheel speeds at the wheels of the right side of the vehicle; and
the difference of the wheel speeds between diagonally situated wheels is determined;

16. The method of claim 13, wherein the monitoring is performed by comparing a tire-state variable representing the current operating state of the tire, to a calibration data record, the calibration data record being determined at a predefined time.

17. The method of claim 16, wherein the predefined time is specified at least one of independently of a tire change, and by a command initiated by a driver of the vehicle.

18. The method of claim 13, wherein trailer operation is detected via at least one of an electrical coupling of the trailer, a mechanism in the trailer hitch, a switch to be operated manually, driving-dynamics characteristics of the vehicle, normal forces at the wheels of the vehicle, and a power balance of electrical loads.

19. The method of claim 18, wherein the driving-dynamics characteristics of the vehicle include a torque balance.

20. The method of claim 13, wherein the monitoring is performed as a function of a bearing load of the trailer on the vehicle, the bearing load being determined as a change in the weight force on the vehicle during trailer operation, and a modification of the calibration data record being provided as a function of the bearing load.

21. The method of claim 13, wherein the tire state is monitored by determining a current tire-state variable, a malfunction of the tire state being detected when a determined tire-state variable is outside of a predefined range in relation to a calibration data record.

22. The method of claim 21, wherein the driver of the vehicle is informed, at least one of optically and acoustically, about an occurrence of a malfunction.

23. The method of claim 21, wherein in response to a detected malfunction, an operating state of a driving-dynamics system in the vehicle is modified to stabilize the vehicle, the operating state of the driving-dynamics system being characterized by the variables used for operating the driving-dynamics system that includes at least one of a brake system, an active steering system, and a suspension control system.

24. A brake system for use with a monitoring system, an operating state of the brake system being characterized by variables used for operating the brake system, the system comprising:
a brake system, wherein the monitoring system is operable to monitor an operating state of at least one tire of a vehicle by providing a tire state of the wheel as an operating state of the tire state of the wheel, and monitoring the tire state as a function of a coupling of a trailer to the vehicle.

25. A device for monitoring an operating state of a least one tire of a vehicle, a tire state of the wheel being an operating state of the tire state of the wheel, the device comprising:
a monitoring arrangement to monitor the tire state as a function of a coupling of a trailer to the vehicle.

26. The device of claim 24, wherein the monitoring is performed by comparing a tire-state variable representing the current operating state of the tire, to a calibration data record, the calibration data record being determined at a predefined time that is specified at least one of independently of a tire change and by a command initiated by the driver of the vehicle.

27. The device of claim 25, wherein the monitoring is performed as a function of a bearing load of the trailer on the vehicle, the bearing load being determined as a change in the weight force on the vehicle during trailer operation, and a modification of a calibration data record being provided as a function of the bearing load.
